(19) United States
(12) Patent Application Publication
(10) Pub. No.: US 2022/0312978 A1
(43) Pub. Date: Oct. 6, 2022

(54) SMART CHAIR CONTROL SYSTEM LINKED WITH RESERVATION

(71) Applicant: HYESUNG. MFG.CO.,LTD., Incheon (KR)

(72) Inventors: Jin Chul KIM, Seoul (KR); Jae Beom MOON, Seoul (KR)

(73) Assignee: HYESUNG. MFG.CO.,LTD., Incheon (KR)

(21) Appl. No.: 17/608,882

(22) PCT Filed: Jun. 29, 2020
(86) PCT No.: PCT/KR2020/008432

§ 371 Date: Nov. 4, 2021

(30) Foreign Application Priority Data
Jul. 31, 2019 (KR) 10-2019-0092983

(51) Int. Cl. A47C 7/60; A47C 7/72; A47C 1/121; G06Q 10/02

(52) U.S. Cl. CPC A47C 7/60; A47C 7/723; A47C 1/121; G06Q 10/02

(57) ABSTRACT

A smart chair control system linked with a reservation is proposed. the system is configured to include: a reservation server (120); a chair control system server (130) configured to interwork with the reservation server (120) and receive ticket reservation information from the reservation server (120); a main controller (140) configured to communicate with the chair control system server (130); a sub-controller (150) configured to communicate with the main controller (140); and a chair control board (155) configured to control a chair of a grandstand by communicating with the sub-controller.

### TECHNICAL FIELD

The present invention relates to a smart chair control system linked with a reservation, the system unlocking locking devices for reserved chairs and keeping locked states for non-reserved chairs according to status of the reservation.

### BACKGROUND ART

Connected chairs, which are installed in a place such as a multiplex theater or a performance hall, have a plurality of individual chairs installed sideways in line.

Meanwhile, there is a need for a means where a locking device installed in each chair in a multiplex theater, a performance hall, a movie theater, and the like and capable of locking or unlocking a seat is operated such that the locking device is unlocked for a reserved chair and is kept in a locked state for a non-reserved chair. That is, a seat management system is needed wherein the reserved chair is allowed to be sat in by a spectator by releasing the locked state by the locking device and the non-reserved chair is prevented from being sat in by the spectator. In a case of a movie theater, movies are screened at fixed time slots in a day, and there are cases where even after watching the movies during the corresponding time slots, the spectators do not leave the movie theater and watch other movies in the next time slots again. In some cases, the spectators move to other seats and watch the movies in the next time slots again, causing a problem.

### DISCLOSURE

### Technical Problem

The present invention has been developed to solve the above problem, and an objective of the present invention is to provide a smart chair control system linked with a reservation, wherein the system having a new configuration improves efficiency of chair management by unlocking a locking device for a reserved seat and keeping a locked state for a non-reserved chair according to reservation status of chairs for viewing in a film screening hall such as a multiplex theater, a performance hall, and a movie theater.

### Technical Solution

According to the present invention for solving the above problem, there is provided a smart chair control system linked with a reservation, the system including: a reservation server; a chair control system server configured to interwork with the reservation server and receive ticket reservation information from the reservation server; a main controller configured to communicate with the chair control system server; a sub-controller configured to communicate with the main controller; and a chair control board configured to control a chair of a grandstand by communicating with the sub-controller.

### Advantageous Effects

In the smart chair control system linked with the reservation according to the present invention, the smart chair control system is a means where a locking device installed in a chair in a multiplex theater, a performance hall, a movie theater, and the like and capable of locking or unlocking a seat is operated such that the lock device releases a locked state of the seat for a reserved chair and keep the locked state for a non-reserved chair, whereby the reserved chair is allowed to be sat in by a spectator by releasing the locked state by the locking device and the non-reserved chair is prevented from being sat in by the spectator.

### DESCRIPTION OF DRAWINGS

FIG. 1 is a view showing a configuration of a smart chair control system linked with a reservation according to the present invention.

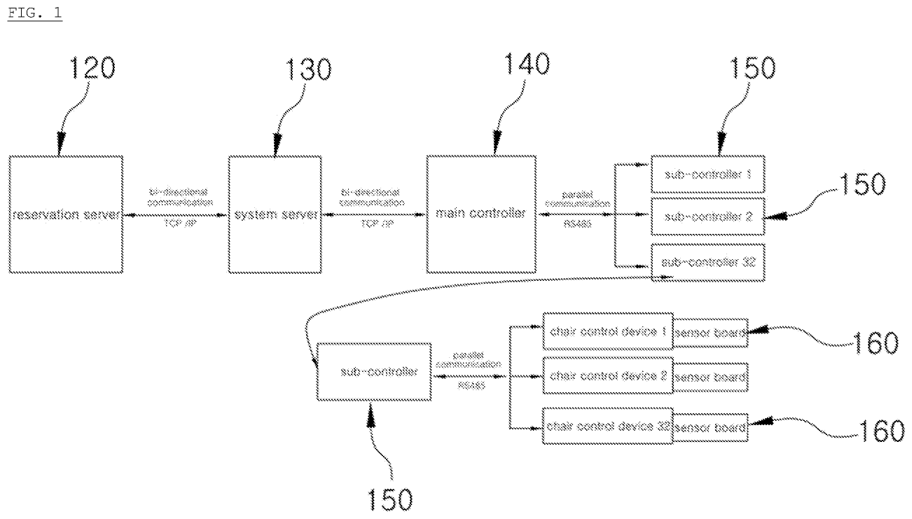

FIG. 2 is a view schematically showing a structure of sub-controllers, chair control boards, chair control devices, and sensor boards, which are a main part of the present invention.

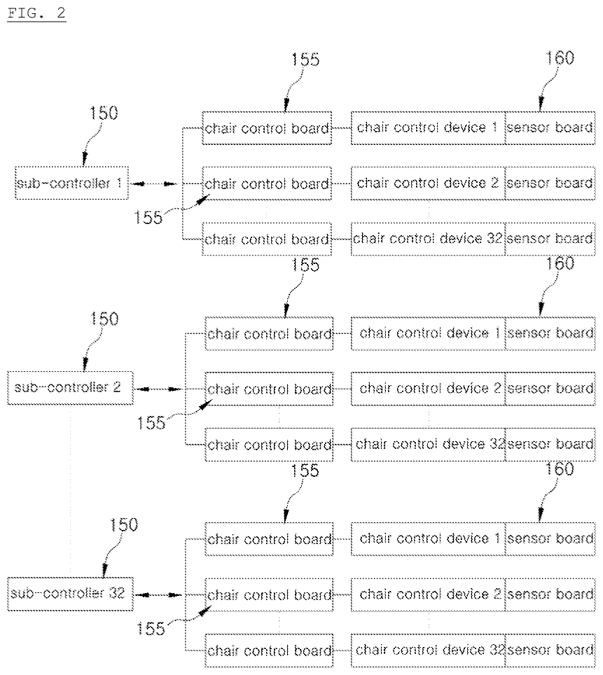

FIG. 3 is a view showing a configuration of the smart chair control system linked with the reservation of the present invention, the view showing pressure sensors.

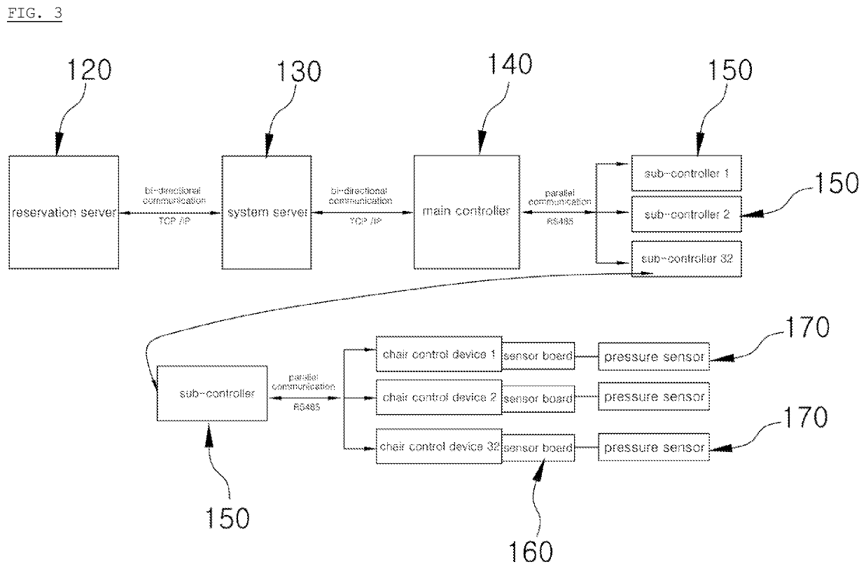

FIG. 4 is a side view showing an exemplary embodiment of a chair control device in the smart chair control system linked with the reservation of the present invention, the side view showing an operation state of a latch and a cam when a chair seat is switched to a locked state.

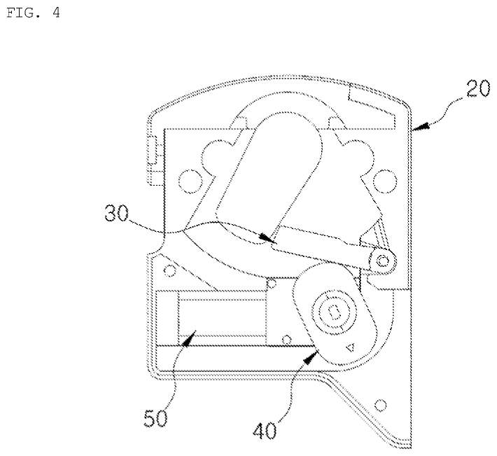

FIG. 5 is a side view showing the configuration of the chair control device shown in FIG. 4, illustrating an operation state of the latch and the cam when the chair seat is switched to an unlocked state.

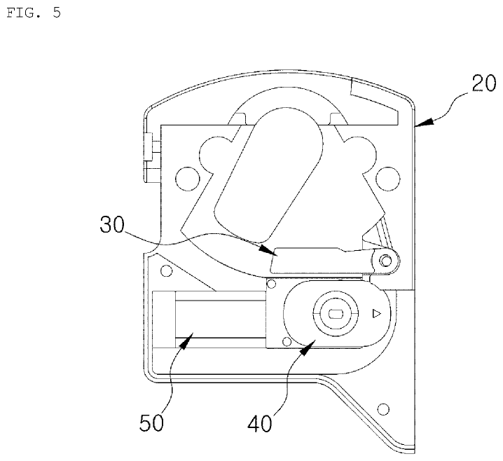

FIG. 6 is a view showing a state in which the chair seat is switched to the locked state by the chair control device shown in FIG. 4.

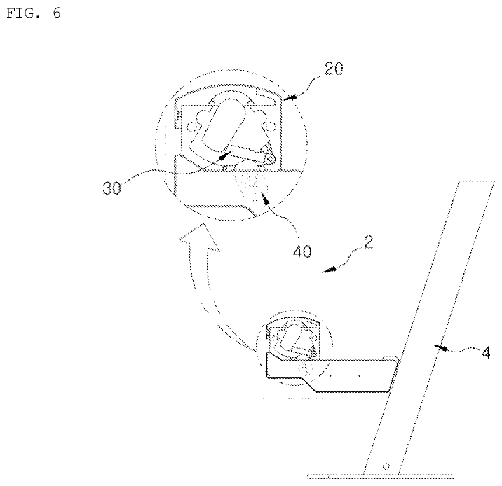

FIG. 7 is a view showing a state in which the chair seat is switched to the unlocked state by the chair control device shown in FIG. 4.

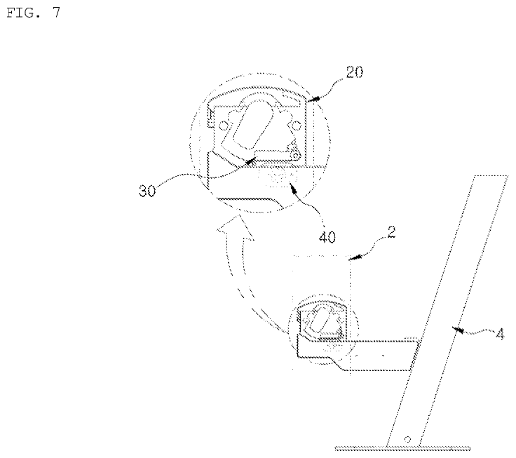

### BEST MODE

A smart chair control system linked with a reservation of the present invention is best configured to include: a reservation server; a chair control system server configured to interwork with the reservation server and receive ticket reservation information from the reservation server; a main controller configured to communicate with the chair control system server; a sub-controller configured to communicate with the main controller; and a chair control board configured to control a chair of a grandstand by communicating with the sub-controller, wherein the chair is provided with the chair control device, the chair control device is provided with a cam and a latch, a seat of the chair is provided with a locking wing piece whose rotation is restricted by the latch, and a sensor board is provided with a lock sensor and an unlock sensor, so the lock sensor and the unlock sensor detect positions of the cam, thereby detecting a locked state and an unlocked state of the chair.

### Mode of Invention

A smart chair control system linked with a reservation according to the present invention is provided with: a reservation server 120 configured to enable the reservation to be made for a chair of a grandstand in a film screening hall; a chair control system server 130 configured to interwork with the reservation server 120; a main controller 140 configured to communicate with the chair control system server 130; a sub-controller 150 configured to communicate with the main controller 140; a chair control board 155 configured to control the chair of the grandstand; and the sensor board 160 configured to detect a locking state and an unlocking state of a seat 2 provided in the chair. In installing a locking device on the chair of a multiplex theater, a performance hall, a movie theater, and the like and controlling the seat 2 to be locked/unlocked, the present invention is a system including: a main controller capable of conducting TCP/IP communication with upper layer side devices and an Internet-based PC, which is configured to receive reservation information of a film screening hall, and also capable of conducting parallel communication with lower layer side devices; a sub-controller 150 capable of controlling, in parallel, the chairs arranged in rows; a chair control board configured to control the chairs; and a sensor board 160 configured to detect locked/unlocked positions of the seat 2 of the chair. In the present invention, the film screening hall means a place where content is screened, the place including an opera house, a movie theater, a performance hall, and the like.

The reservation server 120 allows spectators to reserve tickets for viewing. By connecting mobile phones or PCs of the spectators to the reservation server 120 based on Internet communication, the spectators may reserve the tickets for viewing from the reservation server 120. The reservation server 120 displays, on screens of the spectators' mobile devices or PCs, information necessary for the reservations, the information including seats, viewing dates, and viewing time of a performance hall (e.g., movie theater or theater for theatrical performances, etc.), so as to allow the spectators to reserve tickets by selecting desired seats, viewing dates and time, etc. The reservation server may be built in a place outside a film screening hall, such as a multiplex theater or a movie theater. The reservation server may be built in a place outside the theater, for example, in a reservation control center.

The chair control system server 130 is configured to interwork with the reservation server 120 in the Internet communication method. For example, the chair control system server 130 is configured to interwork with other devices in a TCP/IP communication method. The chair control system server 130 conducts bi-directional communication with the reservation server 120. The chair control system server 130 receives reservation information of a film screening hall from the reservation server 120. The chair control system server 130 may be configured as an Internet-based PC that receives the reservation information of the film screening hall. The chair control system server 130 may be provided with a display for displaying, on a screen of the display, a reservation state of the chair and a lock state and an unlock state of the chair. The chair control system server 130 may be built in a film screening hall, such as a multiplex theater or a movie theater. The chair control system server 130 may be built in a place, such as a center or booth of the chair control system server 130, which is provided in the film screening hall.

The main controller 140 is configured to interwork with the chair control system server 130 in an Internet-based communication method. The main controller 140 is configured to interwork with the chair control system server 130 in a TCP/IP communication method. The main controller 140 may be built in a film screening hall, such as a multiplex theater or a movie theater. The main controller 140 may conduct TCP/IP communication with the upper layer side devices and parallel communication with the lower layer side devices. The upper layer side devices mean the chair control system server 130 and the like, and the lower layer side devices mean a plurality of sub-controllers 150 to be described later. The main controller 140 receives seat reservation information of the film screening hall through the chair control system server 130 and conducts parallel communication with the sub-controllers 150 of the lower layer side. The main controller 140 is configured to simultaneously control the sub-controllers 150 through parallel connections. For example, the main controller 140 may simultaneously control 32 sub-controllers 150 through parallel connections. In this case, a theater control part is provided in the main controller 140, and the sub-controllers 150 are connected in parallel to the theater control part of the main controller 140, whereby it may be configured such that the main controller 140 simultaneously controls the plurality of sub-controllers 150 through parallel connections. For example, the 32 sub-controllers 150 are connected to the theater control part of the main controller 140, and the main controller 140 may be configured to simultaneously control the 32 sub-controllers 150 in parallel connection.

Having the plurality of sub-controllers 150 connected thereto in parallel, the main controller 140 may be configured to simultaneously control the plurality of sub-controllers 150 by parallel connection.

The sub-controllers 150 are connected to the main controller 140 by a communication network. The sub-controllers 150 are connected to the main controller 140 by an Internet-based communication network. In the present invention, the plurality of sub-controllers 150 is connected in parallel to the main controller 140 through a TCP/IP communication method. The plurality of sub-controllers 150 is configured to conduct bi-directional communication with the main controller 140. For example, the 32 sub-controllers 150 are configured to conduct bi-directional communication with the main controller 140. Each sub-controller 150 controls, in parallel, the chairs arranged in rows in the film screening hall. Each sub-controller 150 is configured to have a unique ID as a selection switch. Each sub-controller 150 may be configured to have the unique ID for controlling the chairs arranged in rows of the grandstand.

Each of the chairs arranged in parallel in the film screening hall is provided with the chair control device. The fact that the chairs are arranged in parallel means that the chairs are arranged in rows and columns. The chair in such a film screening hall is provided with the chair control device. Opposite sides of the seat 2 that is rotatable by a shaft are attached to chair legs 4 of the chair, and the chair control device may be configured to include a motor 50 having a motor shaft connected to a shaft protruding sideways of the seat 2 by a connecting means such as a coupler. By rotation of the motor shaft of the motor 50, the seat 2 of the chair may be configured to be unfolded in a horizontal direction and to be erected in an up and down direction. Meanwhile, the chair control device may be configured to include: a fixing body 20 coupled to a side surface of the seat 2 of the chair and provided with a locking wing piece 6, in an accommodation part thereof, protruding to a side of the seat 2; a latch 30 coupled to the fixing body 20 via a shaft; a motor 50 provided in the fixing body 20; a cam 40 coupled to a motor shaft 152 of the motor 50 and rotatably arranged on the fixing body 20 and configured to enable the latch 30 to be rotated downward relative to the shaft at a position where the latch 30 is pushed upward to rotate relative to the shaft; and a sensor board 160 provided with a lock sensor and an unlock sensor and arranged between the motor 50 and the cam 40.

The chair control board 155 is configured to communicate with the sub-controller 150 and controls the chair of the grandstand. The chair control board 155 is configured to control the locked state of the chair control device provided on the seat 2 of the spectator chair. The chair control board 155 is configured to have a unique ID as a selection switch. The chair control board 155 may be configured to have the unique ID for controlling one of the plurality of chairs arranged in rows of the grandstand. The chair control board 155 is configured to communicate with the sub-controller 150 in an Internet-based communication method. For example, the chair control board 155 may be configured to communicate with the sub-controller 150 in an RS485 communication method. The chair control board 155 is connected to the chair control device, so as to control the seat 2 of the chair. The chair control board 155 is connected to a motor 50 of the chair control device, so as to control the rotation of the motor shaft of the motor 50, thereby controlling to switch the seat 2 of the chair into a locked state or an unlocked state. A chair control board 155 may be mounted on the seat 2 or leg 4 of the chair. The sub-controller 150 may be connected to the chair control board 155. The sub-controller 150 may be connected to a chair control part provided on the chair control board 155. The chair control boards 155 are provided in plural so as to control the plurality of chairs, and the sub-controller 150 is connected to the plurality of chair control boards 155. The sub-controller 150 may be configured to connect in parallel to the chair control part provided in each chair control board 155.

The chair control device is provided in the chair, the chair control device is provided with a cam 40 and a latch 30, the seat 2 of the chair is provided with a locking wing piece whose rotation is restricted by the latch 30, and the sensor board 160 is provided with a lock sensor and an unlock sensor, so the lock sensor and the unlock sensor, which are provided in the sensor board 160, detect positions of the cam 40, thereby detecting a locked state and an unlocked state of the seat 2 of the chair. The sensor board 160 is configured to be provided in the fixing body 20 and at the same time arranged between the motor 50 and cam 40 of the fixing body 20.

The sensor board 160 detects the locking state and the unlocking state of the seat 2 provided in the chair of the grandstand. The sensor board 160 is provided with an unlock sensor and a lock sensor, and is configured to respectively detect the lock state and the unlock state of the seat 2 of the chair according to the rotation positions of the cam 40.

A process of controlling the chair in a film screening hall in conjunction with a ticket reservation according to the present invention of the above configuration will be described.

In the reservation server 120, when a movie goer makes a reservation for a ticket for content of a film screening hall (e.g., a movie in a movie theater), reservation information is stored. When the spectator accesses a site of the film screening hall through the Internet by using a reservation input device such as a PC or mobile device and purchases a content ticket, or directly makes a reservation for the content ticket from the reservation receiving device provided in the film screening hall, the reservation server 120 stores content ticket reservation information of the film screening hall. The reservation information refers to information necessary for content screening, such as content and show time.

The chair control system server 130 receives the reservation information of the film screening hall from the reservation server 120. Since the chair control system server 130 is interworked with the reservation server 120 of the film screening hall in a TCP/IP communication method, the chair control system server 130 receives the reservation information of the film screening hall from the reservation server 120. In this case, the chair control system server 130 has a screen that displays the reservation state of the chair and the locked state and unlocked state of the chair. The chair control system server 130 is provided with a screen display device such as a display to display the reservation state of the chair and the lock state and unlock state of the chair on the display of the chair control system server 130.

The main controller 140 receives the reservation information transmitted from the chair control system server 130 and communicates in parallel with sub-controllers 150 on the lower layer side. The main controller 140 issues a lock state switch signal command or an unlock state switch signal command to the corresponding sub-controllers 150 on the lower layer side on the basis of the reservation information.

The sub-controllers 150 are provided in plurality to control the seats 2 of the film screening hall in parallel. The plurality of sub-controllers 150 controls the seats 2 of the film screening hall in parallel for each row. For example, when there are 32 rows of seats 2 in the film screening hall, the seats arranged in 32 rows in the film screening hall are controlled in parallel on the basis of the reservation information received from the main controller 140. The sub-controller 150 controls the seats for each row in conjunction with the control boards (i.e., chair control boards).

Each chair control board individually controls the plurality of chairs in the film screening hall. The chair is provided with the chair control device, and by operating the chair control device by the chair control board, the seat 2 of the chair is kept in a locked state or in an unlocked state.

In a state where the seat of the film screening hall is erected in the up and down direction, the main controller 140 receives the chair non-reservation information from the sub-controller 150, and then the sub-controller 150 transmits the seat non-reservation information to the chair control board, so that chair control device is operated by the chair control board, whereby the seat 2 of the chair is erected in the up and down direction and kept in a locked state not to be unfolded. The reservation information of the chair is transmitted from the reservation server 120 to the corresponding chair control board through the chair control system server 130, the main controller 140, and the corresponding sub-controller 150, so that the chair control board operates the motor 50 provided in the chair control device, whereby the non-reserved chair is kept in a locked state where the seat is folded in the horizontal direction in the upright state.

In this case, when the chair control device is composed of a fixing body 20, a latch 30, a motor 50, a cam 40, and a sensor board 160, the cam 40 and the latch 30 are operated by the motor 50, so that a locking wing piece protruding to a side of the seat 2 of the chair is locked, whereby the seat 2 of the non-reserved chair is kept in a locked state in which the seat 2 is not unfolded downward while standing in the up and down direction. When the motor shaft 52 of the motor 50 is rotated in one direction in a state where a long shaft of the cam 40 is laid down in the horizontal direction, as the cam 40 is also rotated upwardly, the cam 40 lifts the latch 30 upward relative to the long shaft. Then, the locking wing piece 6 connected to the seat 2 of the chair is locked by the latch 30 so that the seat 2 of the chair is in an upright state, whereby the seat 2 is held in the locked state in which the seat 2 does not rotate in the horizontal direction. The non-reserved chair receives a signal from the reservation server 120, rotates the cam 40 in one direction to stop the cam 40, and lifts the latch 30 by the cam 40. In the state in which the latch 30 is lifted, since the locking wing piece 6 is unable to rotate to the right, the seat 2 is not unfolded. Such a state is the lock state. When the cam 40 is stopped by rotating the cam 40 in one direction, the latch 30 is lifted higher upward than the horizontal direction, so that even when the seat 2 of the chair is tried to be unfolded downward from the upright state, as the locking wing piece 6 mounted on the seat 2 is locked by the latch 30, the seat 2 is in a locked state where the seat is unable to be unfolded downward.

When there are corresponding reserved chairs among the chairs arranged in rows of the film screening hall, the main controller 140 transmits the chair reservation information to a sub-controller 150, and then the sub-controller 150 transmits the chair reservation information to a chair control board, so that the chair control board operates a chair control device in a locked state in which the seat 2 of the chair is erected in the up and down direction, whereby the seat 2 of the chair is held in an unlocked state where the seat 2 is unfolded in the horizontal direction. The reservation information of the chair is transmitted from the reservation server 120 to a chair control board through the chair control system server 130, the main controller 140, and a sub-controller 150, so that the chair control board operates the motor 50 provided in the chair control device, whereby the reserved chair is kept in an unlocked state where the seat is unfolded in the horizontal direction from the upright state.

In this case, when the chair control device is composed of a fixing body 20, a latch 30, a motor 50, a cam 40, and a sensor board 160, the cam 40 and the latch 30 are operated by the motor 50, so that a locking wing piece protruding to a side of the seat 2 of the chair is switched to be unlocked, whereby the seat 2 of the reserved chair is switched to an unlocked state in which the seat 2 is unfolded downward from a state where the seat is erected in the up and down direction. In a state where the long shaft of the cam 40 is rotated in the up and down direction (i.e., in a state where the cam 40 is stopped between 80° and 90° by rotating the cam 40 clockwise as described above), when the motor shaft 52 of the motor 50 is rotated in the opposite direction, as the cam 40 is also rotated downward again, the latch 30 may be rotated downward relative to the shaft. In this case, between a base end of the latch 30 and the fixing body 20, a spring 34 is interposed (e.g., a torsion spring is interposed) so that the latch 30 is rotated downward by the force of the spring. The latch 30 may be configured to rotate downward in the horizontal direction by its own weight relative to the axis of the base end. When the cam 40 is rotated in the horizontal direction and the latch 30 is lowered to a position where the latch 30 is not locked by the locking wing piece 6 connected to the seat 2 of the chair, the locking wing piece 6 of the seat 2 is not locked by the latch 30, so that the seat 2 of the chair is in an unlocked state in which the seat 2 may be unfolded downward from the upright state. The reserved chair receives a signal from the reservation server 120 and rotates the cam 40 in the opposite direction to maintain the cam 40 horizontally, and in this case, the latch 30 descends relative to the axis of the base end thereof by the force of the spring 34 or comes down relative to the axis of the base end by its own weight. In a state where the latch 30 is horizontally lowered, since the locking wing piece 6 of the seat 2 may rotate to the right, the seat 2 may be switched to the unlocked state in which the seat 2 is unfolded.

The cam 40 is coupled to the motor shaft 52 of the motor 50, and the cam 40 is detected by the lock sensor 56 and the unlock sensor 58, which are respectively positioned at two positions. When detected by the lock sensor 56, a locked state is transmitted to the reservation server 120, and when detected by the unlock sensor 58, an unlocked state is transmitted to the reservation server 120. In a state where the cam 40 is erected upward, the locked state is detected by the lock sensor 56 and transmitted to the reservation server 120. The locked state of the seat 2 of the chair is transmitted from a sensor board 160 to the reservation server 120 through a chair control board, a sub-controller 150, and the main controller 140. In addition, in a state where the cam 40 is rotated downward in the horizontal direction, the cam 40 is detected by the unlock sensor 58, whereby the unlocked state is transmitted to the reservation server 120. The unlocked state of the seat 2 of the chair is transmitted from the sensor board 160 to the reservation server 120 through the chair control board, the sub-controller 150, and the main controller 140.

In this case, the system of the present invention is operated according to each situation.

The cam 40 is coupled to the shaft of the motor 5, and such a cam 40 is detected by the lock sensor and the unlock sensor, which are respectively positioned at two positions, wherein in a case where the drive motor 50 malfunctions, when the case is detected by the lock sensor, the locked state is transmitted to the server, and when the case is detected by the unlock sensor, the unlocked state is transmitted to the server, and when neither sensor detects the case, it is determined as under control, so that data is transmitted to the server. In this case, the server refers to the chair control system server 130. When a locked state is detected, the locked state of the seat 2 of the chair is transmitted from the lock sensor on the sensor board 160 to the chair control system server 130 through the sub-controller 150 and the main controller 140, or the unlocked state of the seat 2 of the is transmitted from the unlock sensor on the sensor board 160 to the chair control system server 130 through the sub-controller 150 and the main controller 140. Since the lock sensor and unlock sensor of the sensor board 160 bi-directionally communicate with the sub-controller 150, the main controller 140, and the chair control system server 130, the locked state and unlocked state may be respectively transmitted from the lock sensor and the unlock sensor of the sensor board 160 to the chair control system server 130 through the sub-controller 150 and the main controller 140.

The determination of the locked state or the unlocked state of the seat 2 (i.e., cushion) of a chair is determined by detecting the cam 40 by sensors at two positions, that is, the lock sensor and the unlock sensor, wherein when the lock sensor does not detect the cam 40, the lock sensor failure is determined on the basis of a signal that the unlock sensor in the opposite position detects the cam 40 and the latch 30 is switched to the unlocked position, so that the seat 2 of the chair may be unlocked, whereby the motor 50 is driven to rotate the motor shaft. The latch 30 is lowered to the unlocked position so that the seat 2 of the chair may be unfolded from the upright state, whereby the motor 50 is driven to rotate the motor shaft. Then, the seat 2 of the chair is switched from an upright state to the unlocked state in which the seat 2 may be unfolded. The operation of driving the latch 30 to be switched to the unlocked state is performed by the chair control system server 130 and a control board. The chair control system server 130 and the main controller 140 transmit a control signal to the control board so that the operation of driving the latch 30 to be switched to the unlocked state is performed.

Whereas, when the unlock sensor malfunctions and the lock sensor detects the same, a control signal is transmitted to drive the motor 50 to the unlocked position. On the basis of the signal that the lock sensor in the opposite position detects the cam 40, the unlock sensor failure is determined, and the latch 30 is rotated to the locked position, so that the seat 2 of a chair may be locked, whereby the motor 50 is driven to rotate the motor shaft. Then, in the state where the seat 2 of the chair is erected, the unlocked state is switched to the locked state in which the locking wing piece protruding to the side of the seat 2 of the chair may be caught to the latch 30. The operation of driving the latch 30 to be switched to the locked state is performed by the chair control system server 130 and a control board. The chair control system server 130 and the main controller 140 transmit the control signal to the control board so that the operation of driving the latch 30 to be switched to the locked state is performed.

Meanwhile, the present invention further includes a pressure sensor 170 mounted on the seat 2 of the chair. The pressure sensor 170 may be configured to connect to the sub-controller 150. The pressure sensor 170 may be configured as a weight sensing sensor or a weight sensing pad. The weight sensing pad may be composed of a sensor that detects a seated state when a person sits on the seat 2, similar to a case where a button on a cell phone is pressed. When the pressure sensor 170 is mounted on the seat 2 of the chair and a weight corresponding to the weight of a person sitting thereon is measured, it is determined that the seat is sat in and a seated signal is transmitted to the server side through a controller. In this case, the controller means the sub-controller 150 and the main controller 140, and the server means the chair control system server 130.

The server displays seating status on a ticket sales display window, a seat lock display window, and a seat unlock display window, so as to collect data such as sales and seating. The server is provided with a display to display the seating status on the ticket sales display window, the seat lock display window, and the seat unlock display window. In this case, the server is the chair control system server 130.

When the person gets up from the seat 2 of a chair, the seat 2 (i.e., cushion) should be automatically rotated to the opposite direction and upright, so that the motor 50 rotates and the latch 30 performs a locking operation. In this regard, there is a control operation function to move the latch 30 to the unlocked state after three consecutive attempts when the rotation to the opposite direction of the seat 2 is not performed properly due to mechanical defects and the like and the latch 30 is unable to move to the locked state. A chair control board may be allowed to move the latch 30 to the unlock state.

In this case, when there is a spectator who came to a film screening hall and manually purchased a screening ticket at a sales counter, the locked state of a chair control device for a chair for which the ticket was manually purchased is controlled through the main controller, so that the locked state may be configured to be switched to the unlocked state by the chair control board and the sub-controller of the chair.

Meanwhile, in the present invention, in a state where content screen time is classified by each time slot, when the content screen time ends, all ticket reservation states are reset, thereby switching to the ticket reservation state of the next time slot. After entering a chair control mode for each time slot, when the content screen time of the corresponding time slot ends, the chair control mode is reset to enter the content screening mode of the next time slot.

An effect of the smart chair control system linked with the reservation of the present invention of the above configuration is as follows.

In the present invention, a locking device installed in a chair in a multiplex theater, a performance hall, a movie theater, and the like and capable of locking or unlocking a seat 2 is operated such that the lock device releases a locked state of the seat 2 for a reserved chair and maintain the locked state for a non-reserved chair, whereby the reserved chair is allowed to be sat in by a spectator by releasing the locked state by the locking device and the non-reserved chair is prevented from being sat in by the spectator. For example, in a case of a movie theater, movies are screened at fixed time slots in a day, and there are cases where even after watching movies during corresponding time slots, spectators do not leave the movie theater and watch other movies in the next time slots again. The present invention is the smart chair control system linked with the reservation, and the system solves the problem in which the spectators move to other seats and watch the movies in the next time slot again.

In addition, in the present invention, while controlling a chair linked with a reservation, it is possible to identify how much reservations have been made for screening content and a ratio of people who have reserved tickets and do not show. The system of the present invention may also serve as a reminder of the content screen time to pre-orderers when the screen time is imminent by identifying how much screening content has been reserved.

Meanwhile, there are cases where the chair control devices do not work properly due to various factors, and in such cases, it was not easy to control (i.e., manage) the cases one by one.

However, in the present invention, when the chair control devices do not work properly, it is easy to control because it is possible to immediately deal with the malfunctions. In this case, when the chair control devices do not work properly, it is possible to set a date for each unit period and allow the chair control devices to be managed. For example, by setting a date on a weekly basis to manage chairs that are not functioning properly, for example the chair control devices with malfunctions, etc., it is more flexible and easier in management work.

In addition, management problems may be solved by managing, right in time, the chair control devices and/or the like that do not work properly due to failures.

Meanwhile, in the present invention, reservation-related control is possible in the chair control system server 130 as well. For example, when a problem occurs in the reservation server 120, the chair control system server 130 itself is allowed to receive reservations or manage other chair control functions, whereby it is possible to perform the ticket reservation related control.

In addition, it may be configured to enable reservation-related control in a film screening hall itself, such as a theater. By implementing the main controller 140 in the film screening hall, when a problem occurs in the reservation server 120, the main controller 140 enables control of the sub-controllers 150, which are a lower layer side device, thereby enabling the film screening hall itself to perform the reservation-related control.

In addition, the plurality of sub-controllers 150 is implemented for each hall, such as, for example, hall 1, hall 2, and hall 3 in a movie theater, thereby allowing chairs for each hall to be controlled through the plurality of sub-controllers 150.

### INDUSTRIAL APPLICABILITY

The present invention is the smart chair control system linked with a reservation that is configured to include: a reservation server; a chair control system server configured to interwork with the reservation server and receive ticket reservation information from the reservation server; a main controller configured to communicate with the chair control system server; a sub-controller configured to communicate with the main controller; and a chair control board configured to control a chair of a grandstand by communicating with the sub-controller, whereby the present invention has industrial applicability.

1. A smart chair control system linked with a reservation, the system comprising:
a reservation server (120) configured to enable the reservation to be made for a chair in a film screening hall;
a chair control system server (130) configured to interwork with the reservation server (120) and receive ticket reservation information from the reservation server (120);
a main controller (140) configured to communicate with the chair control system server (130);
a sub-controller (150) configured to communicate with the main controller (140); and
a chair control board (155) configured to control the chair of a grandstand.

2. The system of claim 1, further comprising:
a chair control device provided with a sensor board (160) configured to detect a locked state and an unlocked state of a seat (2) provided in the chair.

3. The system of claim 2, wherein the chair control device is provided in the chair, the chair control device is provided with a cam (40) and a latch (30), the seat (2) of the chair is provided with a locking wing piece whose rotation is restricted by the latch (30), and the sensor board (160) is provided with a lock sensor and an unlock sensor so that the lock sensor and the unlock sensor are configured to detect positions of the cam (40), thereby detecting the locked state and the unlocked state of the seat (2) of the chair.

4. The system of claim 3, wherein the locked state of the chair control device provided on the seat (2) of the chair for viewing is configured to be controlled by the chair control board.

5. The system of claim 1, wherein the chair control system server (130) is provided with a display for displaying, on a screen, a reservation state of the chair and an unlocked state and a locked state of the chair.

6. The system of claim 1, wherein the sub-controller (150) is configured to have a unique ID as a selection switch.

7. The system of claim 1, wherein the main controller (140) is configured to simultaneously control a plurality of sub-controllers (150) through parallel connections.

8. The system of claim 1, wherein the chair control board (155) is configured to communicate with each sub-controller (150) in a parallel communication method.

9. The system of claim 8, wherein the chair control board (155) is configured to perform parallel communication by applying a unique ID as a selection switch.

10. The system of claim 9, wherein the chair control board (155) is configured to rotate a motor (50) installed in the chair through a command received from each sub-controller (150).

11. The system of claim 3, wherein the lock sensor and the unlock sensor are configured as proximity infrared sensors to detect presence or absence of the cam (40).
